(19) United States
(12) Patent Application Publication
(10) Pub. No.: US 2011/0304538 A1
(43) Pub. Date: Dec. 15, 2011

(54) OPTICAL POINTING DEVICE AND ELECTRONIC DEVICE INCLUDING THE OPTICAL POINTING DEVICE

(75) Inventors: Takahiro Miyake, Osaka (JP); Renzaburou Miki, Osaka (JP); Tetsushi Noro, Osaka (JP); Minoru Ueda, Osaka (JP)

(73) Assignee: Sharp Kabushiki Kaisha, Osaka (JP)

(21) Appl. No.: 13/138,173

(22) PCT Filed: Jan. 15, 2010
(86) PCT No.: PCT/JP2010/000210

§ 371 Date: Aug. 16, 2011

(30) Foreign Application Priority Data
Jan. 15, 2009 (JP) 2009-006272

(51) Int. Cl. G06F 3/033

(52) U.S. Cl. 345/158

(57) ABSTRACT

An inclined plane (13) of a prism (12) serving as a light-direction changing element transmits and refracts light emitted from an LED light source (16) so that a contact surface (11) is illuminated with the light thus refracted. The light is diffusely-reflected from an object which is in contact with the contact surface (11). A part of the light thus diffusely-reflected is transmitted through the prism (12). A light path of the part of the light is changed by the inclined plane (13) so that a lens (14) serving as an image-forming element receives the part of the light. The lens 14 forms an image on the basis of the part of the light thus received. An image-capturing element (15) captures the image thus formed as image data. The image data obtained by the image-capturing element (15) is subjected to image processing, so that a change in the contact surface (11) is extracted. On the basis of the change thus extracted, an amount of movement of the object and a direction of the movement can be obtained. With the arrangement, it is possible to realize an optical pointing device having a small and thin body.

### TECHNICAL FIELD

The present invention relates to an input device, particularly, an optical pointing device for use in an electronic device such as a mobile phone.

### BACKGROUND ART

An electronic device having a small body, such as a mobile information terminal (e.g., a mobile phone or a PDA (Personal Digital Assistant)), employs a user interface having a keypad. Such a keypad is constituted by (i) a plurality of buttons via which numbers and characters can be entered, and (ii) a direction button(s). Meanwhile, a display section of a mobile information terminal has been improved in performance in recent years. With such an improvement, a GUI (Graphical User Interface) is now mainly employed in a mobile information terminal.

As functions of an electronic device such as a mobile information terminal become similar to those of a computer, there has been demand for another way of entering information in the electronic device. That is, it has become inconvenient to a user to enter an instruction to carry out a target function by using, as direction keys, a conventional menu key and other function keys. For this reason, there has been demand for a pointing device which allows a user to enter an instruction by use of a mouse, a touch pad, etc., in a manner similar to a manner in which a user enters information in a computer.

As such a pointing device, there has been proposed an optical pointing device which extracts a change in a contact surface by observing, a pattern of an object (such as a fingertip) which touches the optical pointing device (Patent Literature 1). With the arrangement, (i) the contact surface is illuminated with light emitted from a light source, (ii) an image of a pattern on the contact surface is formed on an image-capturing element by use of a lens, and (iii) a change in the pattern is detected as movement of the fingertip, and is converted into an input signal.

An electronic device having a small body, such as a mobile information terminal, is required to have a thin body. That is, the optical pointing device is also required to have a thin body. The optical pointing device is thus required to have a reduction in width (thickness) in a vertical direction. The image-forming optical system described above, however, needs to ensure a distance between the contact surface and the image-capturing element so as to form an image on the image-capturing element on the basis of the light received from the contact surface. Because of this, with the arrangement, it is impossible for the optical pointing device to have a reduction in width in the vertical direction.

In order to satisfy such a request, there has been proposed a method of reducing a width of an optical pointing device in the vertical direction while ensuring a long light path, in which method a light-direction changing element for changing a direction of a light path, such as a prism, is provided directly below a contact surface in the optical pointing device so as to change the direction of the light path into a horizontal direction (Patent Literatures 2 and 3). According to the method, the width of the optical pointing device in the vertical direction is irrespective of how long the length of the light path is, because the direction of the light path is changed into the horizontal direction. The method has been thus proposed to realize a pointing device which has a short width in the vertical direction while ensuring a long light path.

According to the method described in Patent Literature 2, however, it is necessary to secure a certain space above the light-direction changing element so as to (i) lead, to the contact surface, the light emitted from the LED light source and (ii) illuminate, with the light, a fingertip that is in contact with the contact surface. In other words, due to such a limitation on an illumination optical system, a part above the light-direction changing element cannot have a reduction in thickness, and therefore a thickness of the entire optical pointing device cannot be reduced. This reduces a merit of a thin image-forming optical system.

Further, according to the method described in Patent Literature 3, it is also necessary to provide an illumination optical system above a light-direction changing element. Because of this, the optical pointing device cannot have a reduction in thickness.

### CITATION LIST

### Patent Literature

Patent Literature 1
Japanese Patent Application Publication, Tokukai, No. 2007-528554 A

Patent Literature 2
Japanese Translation of PCT International Publication, Tokuhyo, No. 2008-507787 A

Patent Literature 3
Japanese Translation of PCT International Publication, Tokuhyo, No. 2008-510248 A

### SUMMARY OF INVENTION

### Technical Problem

The present invention is made in view of the problems. An object of the present invention is to provide an optical pointing device employing a light-direction changing element, which optical pointing device can have a reduction in size of its body by including an illumination optical system which illuminates an object with light without having an increase in thickness of the illumination optical system.

### Solution to Problem

In order to attain the object, an optical pointing device of the present invention includes: a contact surface which is touched with an object; a light source module for illuminating the contact surface with light; a light-direction changing element having an inclined plane for changing a direction of light diffusely-reflected from the contact surface; an image-forming element for forming an image on the basis of the light diffusely-reflected from the contact surface; and an image-capturing element for capturing the image thus formed, the inclined plane of the light-direction changing element (i) changing a light path of the light diffusely-reflected from the contact surface and (ii) leading the light emitted from the light source module toward the contact surface by transmitting and refracting the light emitted from the light source module.

According to the optical pointing device of the present invention, the inclined plane of the light-direction changing element serves as both (i) a reflecting plane for changing the light path of the light diffusely-reflected from the contact surface and (ii) a transmissive refraction plane for leading, toward the contact surface, the light emitted from the light source module by transmitting and refracting the light emitted from the light source module. With the arrangement, it is possible to (i) reduce the number of optical components of an optical pointing device and (ii) realize the optical pointing device having a small and thin body.

Further, the optical pointing device of the present invention may be arranged such that an optical axis of an image-forming optical system for forming the image on the image-capturing element and an optical axis of an illumination optical system for illuminating the contact surface with the light emitted from the light source module are different from each other.

According to the arrangement, it is possible to prevent the light emitted from the light source module from entering into the image-capturing element as stray light. That is, it is possible to (i) reduce a noise component and therefore (ii) improve a recognition rate of an image.

Furthermore, the optical pointing device of the present invention may be arranged such that the light source module includes (i) a light source and (ii) a lens for suppressing radiant emittance of light emitted from the light source.

According to the arrangement, it is possible to efficiently cause the light emitted from the light source module to travel to the contact surface. This makes it possible to reduce power consumption by reducing an amount of light emission. Further, this reduces stray light. That is, it is possible to (i) reduce a noise component and therefore (ii) greatly improve a recognition rate of an image.

Moreover, the optical pointing device of the present invention may be arranged such that the light source module includes (i) a light source and (ii) an element for leading, into a direction of a normal line with respect to the inclined plane of the light-direction changing element, light emitted from the light source.

According to the arrangement, it is possible to illuminate the object with light in an oblique direction. This causes shadows of an object to be likely to be generated. In this case, contrast is increased in formation of an image of the object such as a fingerprint. It is thus possible to improve a recognition rate of the object.

Further, the optical pointing device of the present invention may be arranged such that the element for leading, into the direction of the normal line with respect to the inclined plane of the light-direction changing element, the light emitted from the light source, is a prism having an inclined light exit plane or a diffraction element.

According to the arrangement, the prism or the diffraction element can be formed integral with a mold section with which the light source such as the LED is sealed. It is thus possible to (i) reduce the number of components of the optical pointing device and (ii) reduce a production cost.

### Advantageous Effects of Invention

According to an optical pointing device of the present invention, it is possible to provide an illumination optical system that is small and thin by arranging an inclined plane of the illumination optical system to serve as (i) a reflecting plane for reflecting diffusely-reflected from an object and (ii) a transmissive refraction plane for leading, toward a surface which is touched with the object, light emitted from a light source module by transmitting and refracting the light emitted from the light source module. It is therefore possible to provide an optical pointing device having a small body.

### BRIEF DESCRIPTION OF DRAWINGS

FIG. 1 is a cross-sectional view illustrating an optical pointing device in accordance with Embodiment 1 of the present invention.

FIG. 2 is a view illustrating an illumination optical system of the optical pointing device in accordance with Embodiment 1 of the present invention.

FIG. 3 is a view illustrating an image-forming optical system of the optical pointing device in accordance with Embodiment 1 of the present invention.

FIG. 4 is a top view illustrating the optical pointing device in accordance with Embodiment 1 of the present invention.

FIG. 5 is a view illustrating an illumination optical system of an optical pointing device in accordance with Embodiment 2 of the present invention.

FIG. 6 is a view illustrating an illumination optical system of an optical pointing device in accordance with Embodiment 3 of the present invention.

FIG. 7 is a view illustrating another illumination optical system in accordance with Embodiment 3 of the present invention.

FIG. 8 is a view illustrating one example of a mobile phone employing the optical pointing device of the present invention: (A) of FIG. 8 is a view illustrating a front side of the mobile phone, (B) of FIG. 8 is a view illustrating a backside of the mobile phone, and (C) of FIG. 8 is a view illustrating a lateral side of the mobile phone.

### DESCRIPTION OF EMBODIMENTS

Embodiment of the present invention are described below. The following descriptions deal with an optical pointing device employing an LED as a light source, as an example. Note that the present invention is not limited to arrangements of the following embodiments. The present invention is applicable to a general optical input interface, provided that the optical input interface employs an arrangement identical with the optical pointing device, such as a scanner device in a fingerprint authentication system or the like.

Note that, in the following embodiments, members having the same function and the same effect have the same sign, and their explanations are not repeated, for the sake of simple explanation.

### Embodiment 1

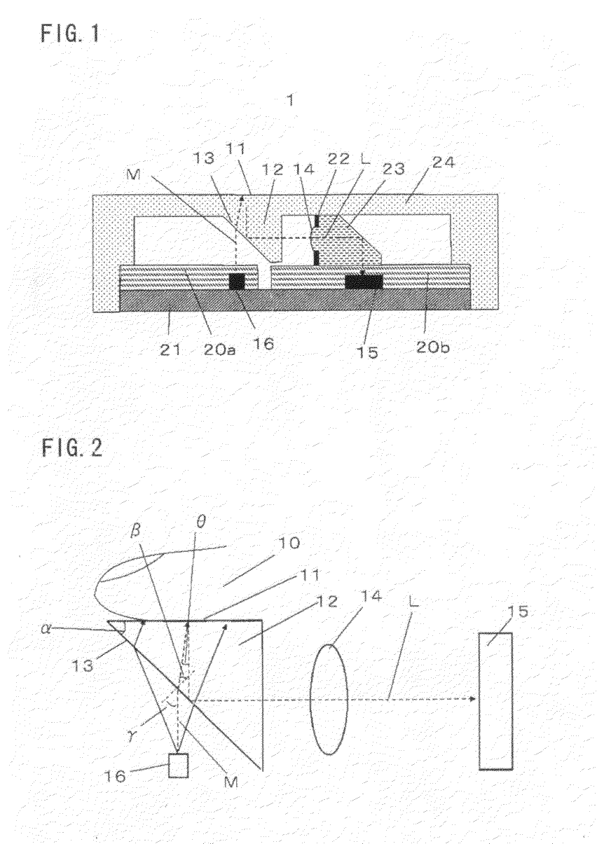

FIG. 1 is a cross-sectional view illustrating an arrangement of an optical pointing device 1 in accordance with Embodiment 1 of the present invention.

An image of an object (not illustrated), such as a fingertip, is captured as light diffusely-reflected from a contact surface 11 which is an upper surface of a prism 12 in a vertical direction. The prism 12 serves as a light-direction changing element. The light thus diffusely-reflected travels in the prism 12, and then is reflected from an inclined plane 13 of the prism 12. The light thus reflected is received by a lens 14 which serves as an image-forming element so that the lens 14 forms an image on the basis of the light thus received. The image formed by the lens 14 is captured by an image-capturing element 15 as image data. The image data obtained by the image-capturing element 15 is subjected to image processing, so that a change in the contact surface 11 is extracted. On the basis of the change thus extracted, an amount of movement of the object and a direction of the movement can be obtained. Further, an LED light source 16 constituting a light source module for illuminating the object with light is provided below the prism 12 (the light-direction changing element).

The prism 12 (the light-direction changing element of the present invention) and the contact surface 11 are formed integral with a cover section of the optical pointing device 1. This (i) reduces a thickness of the optical pointing device 1, and (ii) increases assembly accuracy of the optical pointing device 1 by increasing accuracy of formation of the inclined plane 13.

The lens 14 (the image-forming element) is formed integral with a prism 23 for leading light downwardly. The prism 23 is attached to the cover 24. This makes it possible to manage, with high accuracy, a positional relationship between the inclined plane 13, the lens 14 (the image-forming element), and the prism 23.

An aperture stop 22 is attached to the lens 14 (the image-forming element) so that a lens part of the lens 14 is not covered with the aperture stop 22. The aperture stop 22 intercepts stray light which should not be incident on the lens 14 (the image-forming element).

The image-capturing element 15 is fixed on a circuit substrate 21 and is sealed with a transparent resin 20b, for example. The LED light source 16 is also fixed on the circuit substrate 21 and is sealed with a transparent resin 20a, so as to constitute the light source module. Note, however, that the transparent resin 20a and the transparent resin 20b are separated from each other with a space between them so as to prevent the light emitted from the LED light source 16 from flowing into the image-capturing element 15 via such a transparent resin.

Note that, on the circuit substrate 21 on which the LED light source 16 and the image-capturing element 15 are provided, an image-forming optical system including the prism 23, the lens 14 (the image-forming element), and the like, is arranged on the basis of (i) an upper surface of the transparent resin 20a with which the LED light source 16 is sealed, and (ii) an upper surface of the transparent resin 20b with which the image-capturing element 15 is sealed.

The contact surface 11 is touched with an object, such as a fingertip. The object is illuminated with the light emitted from the LED light source 16, which light is indicated by an optical axis M of an illumination optical system. The light is diffusely-reflected from the object. This creates a diffuse-reflection image. A part of the light forming the diffuse-reflection image serves as image-forming light, which is indicated by an optical axis L of the image-forming optical system. The light forming the diffuse-reflection image is transmitted inside the prism 12. Then, the light forming the diffuse-reflection image is reflected from the inclined plane 13 (preferably, total reflection) so that a light path of the light forming the diffuse-reflection image is changed. The light forming the diffuse-reflection image is then received by the lens 14 (the image-forming element) so that the lens 14 forms an image on the image-capturing element 15. The image formed on the image-capturing element 15 is captured by a DSP (Digital Signal Processor) (not illustrated) as image data.

The image-capturing element 15 is an image sensor, such as a CMOS or a CCD, and keeps capturing images on the contact surface 11 at predetermined intervals. When the object moves, the image thus captured changes by a certain amount, that is, the image thus captured and a previous image captured immediately before the above image become different from each other by the certain amount. The DSP compares the image thus captured with the previous image captured immediately before the image so as to obtain an amount of a difference between identical parts of these images. An amount of movement of the object and a direction of the movement are thus determined.

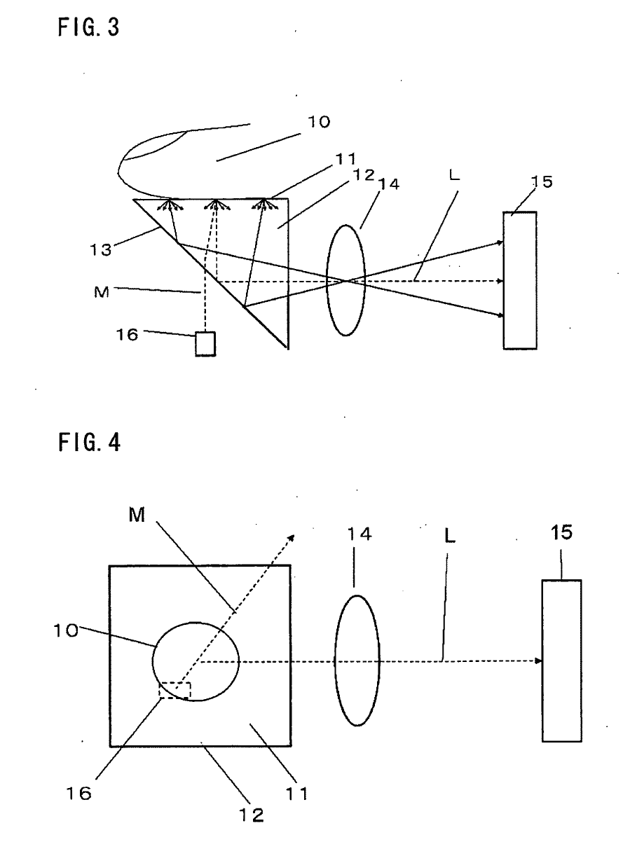

FIG. 2 is a view illustrating how the illumination optical system of the optical pointing device 1 works in accordance with Embodiment 1, in a case where a fingertip 10 is used as the object. FIG. 3 is a view illustrating how the image-forming optical system of the optical pointing device 1 works in accordance with Embodiment 1, in a case where the fingertip 10 is used as the object.

An optical system of the optical pointing device 1 is constituted by (i) the prism 12, serving as the light-direction changing element of the present invention, which has the inclined plane 13, and the contact surface 11 which is to be touched with the fingertip 10 serving as the object, (ii) the lens 14 serving as the image-forming element, (iii) the image-capturing element 15, and (iv) the LED light source 16 for illuminating the fingertip 10 with light.

The LED light source 16 for illuminating the fingertip 10 with light is provided below the prism 12. The inclined plane 13 of the prism 12 transmits and refracts the light emitted from the LED light source 16 so that the contact surface 11 is illuminated with the light in an oblique direction which is indicated by the optical axis M of the illumination optical system.

FIG. 4 is a top view illustrating the optical pointing device 1 illustrated in FIG. 1. The LED light source 16 is positioned obliquely with respect to the optical axis L of the image-forming optical system so that the LED light source 16 does not emit light in the direction of the optical axis L of the image-forming optical system when viewed from above (i.e., when viewed from a fingertip 10 (object) side). With the arrangement in which the optical axis M of the illumination optical system, extending from the LED light source 16 toward the fingertip 10, and the optical axis L of the image-forming optical system are different from each other. It is therefore possible to cause light that is not incident on the fingertip 10 to be less likely to be incident on the image-capturing element 15. This improves a recognition rate, and prevents a malfunction.

The contact surface 11 is touched with the fingertip 10 which serves as the object. The fingertip 10 is obliquely illuminated with the light emitted from the LED light source 16, which light is indicated by the optical axis M of the illumination optical system. The light incident on the fingertip 10 is diffusely-reflected from the fingertip 10 (see FIG. 3).

When the contact surface 11 is touched with the fingertip 10, a diffuse-reflection image of a fingerprint is mainly formed. The light forming the diffuse-reflection image of the fingerprint is transmitted inside the prism 12 as indicated by the optical axis L of the image-forming optical system, and then is reflected (preferably, total reflection) from the inclined plane 13. The light forming the diffuse-reflection image thus reflected is received by the lens 14 serving as the image-forming element so that an image is formed on the image-capturing element 15 on the basis of the diffuse-reflection image. The reflection from the inclined plane 13 may be Fresnel reflection, but it is preferable that the reflection is the total reflection. This is because, as compared with the Fresnel reflection, the total reflection allows more light to be led toward the lens 14. This makes it possible to (i) cause the image obtained by the lens 14 to be brighter and therefore (ii) increase a signal-to-noise ratio.

Here, the image of the fingerprint can be formed in such a manner that (i) the fingerprint is illuminated with light transmitted through the contact surface 11 and (ii) the image is formed on the image-capturing element 15 on the basis of the light that is diffusely-reflected from the fingerprint. In this case, it is necessary to cause the light to be transmitted through the contact surface 11. For this reason, it is necessary to cause the light to be incident on the contact surface 11 at such an angle that the total reflection of the light from the contact surface 11 is suppressed as much as possible. That is, in a case where a refractive index of the prism 12 is “n”, an incident angle θ at which the light is incident on the contact surface 11 should satisfy the following condition (1).

θ<ArcSin(1/n) (1)

Further, in a case where (i) a top angle of the prism 12 is “α”, (ii) an incident angle at which the light emitted from the LED light source 16 is incident on the inclined plane 13 is “γ”, and (iii) an incident angle at which the light emitted from the inclined plane 13 enters into the prism 12 is “β”, the following formula (2) is obtained.

γ=ArcSin(n×Sin(α−θ)) (2)

For example, in a case where the refractive index n of the prism 12 illustrated in FIG. 2 is 1.5, it is necessary to set the incident angle θ at which the light is incident on the contact surface 11 to be smaller than 41.8° to satisfy the above condition (1).

Here, in a case where the top angle α of the prism 12 is 45°, it is necessary to set the incident angle γ at which the light is incident on the inclined plane 13 to be larger than 4.8°.

Alternatively, the image of the fingerprint can be formed by employing such an arrangement that (i) in a case where the fingertip 10 is not in contact with the contact surface 11, the light cannot be transmitted through the contact surface 11 (the total reflection), and (ii) in a case where the fingertip 10 becomes in contact with the contact surface 11, the light is transmitted through the contact surface 11 and is incident on a fingerprint (i.e., a total reflection condition is not satisfied at a contact area), and an image is formed on the image-capturing element 15 on the basis of the light diffusely-reflected from the fingerprint. In this case, it is necessary to cause the light to be subjected to the total reflection from the contact surface 11. For this reason, it is necessary to cause the light to be incident on the contact surface 11 at such an angle that transmission of the light through the contact surface 11 is suppressed as much as possible. That is, in a case where the refractive index of the prism 12 is “n”, the incident angle θ at which the light is incident on the contact surface 11 should satisfy the following condition (3).

θ>ArcSin(1/n) (3)

Further, in a case where (i) the top angle of the prism 12 is “α”, (ii) the incident angle at which the light emitted from the LED light source 16 is incident on the inclined plane is “γ”, and (iii) an exit angle at which the light is emitted from the inclined plane into the prism 12 is “β”, the formula (1) described above is obtained.

For example, in a case where the refractive index n of the prism 12 illustrated in FIG. 2 is 1.5, it is necessary to set the incident angle θ at which the light is incident on the contact surface 11 to be larger than 41.8° to satisfy the formula (3).

Here, in a case where the top angle α is 45°, it is necessary to set the incident angle γ at which the light emitted from the LED light source 16 is incident on the inclined plane 13 to be smaller than 4.8°.

Note that limitations of the aforementioned formulas (2) and (3) would be eliminated in a case where the optical pointing device employs such an arrangement that, with either the light transmitted through the contact surface 11 or the light totally reflected from the contact surface 11, (i) the fingertip 10, serving as the object, can be illuminated and (ii) an image can be formed on the image-capturing element 15 on the basis of the light diffusely-reflected from a fingerprint or the like. That is, it becomes possible to use the light in a wider range of an incident angle with respect to the contact surface 11.

According to the present embodiment, the lens is used as the image-forming element 14. Note, however, that the present embodiment is not limited to this, and a pinhole can be used as the image-forming element 14 instead of the lens. In the case of the pinhole, the image-forming element 14 can have a reduction in thickness. The arrangement using the pinhole is therefore advantageous in miniaturization of the device. On the other hand, in the case of the lens, it is possible to receive more light with a small element. That is, the arrangement using the lens can (i) obtain a brighter image and therefore (ii) increase the signal-to-noise ratio.

As described above, in the optical pointing device 1 of the present embodiment, the inclined plane 13 of the prism 12 serving as the light-direction changing element serves as both (i) a reflecting plane (light-path changing plane) for reflecting (preferably, totally reflecting) the light for forming an image, received from the contact surface 11, which light is indicated by the optical axis L of the image-forming optical system, and (ii) a transmissive refraction plane for leading, toward the contact surface 11, the light emitted from the LED light source 16 by transmitting and refracting the light emitted from the LED light source 16, which light indicated by the optical axis M of the illumination optical system. This makes it possible to reduce the number of components, reduce a production cost, and realize an optical pointing device having a smaller and thinner body.

Further, the light emitted from the LED light source 16 is obliquely incident on the contact surface 11, which light is indicated by the optical axis M of the illumination optical system. This causes shadows of concavities and convexities of the fingertip 10 serving as the object (i.e., shadows of the fingerprint) to be likely to be generated. High contrast can be thus obtained in formation of the image of the fingerprint. It is therefore possible to improve a recognition rate.

### Embodiment 2

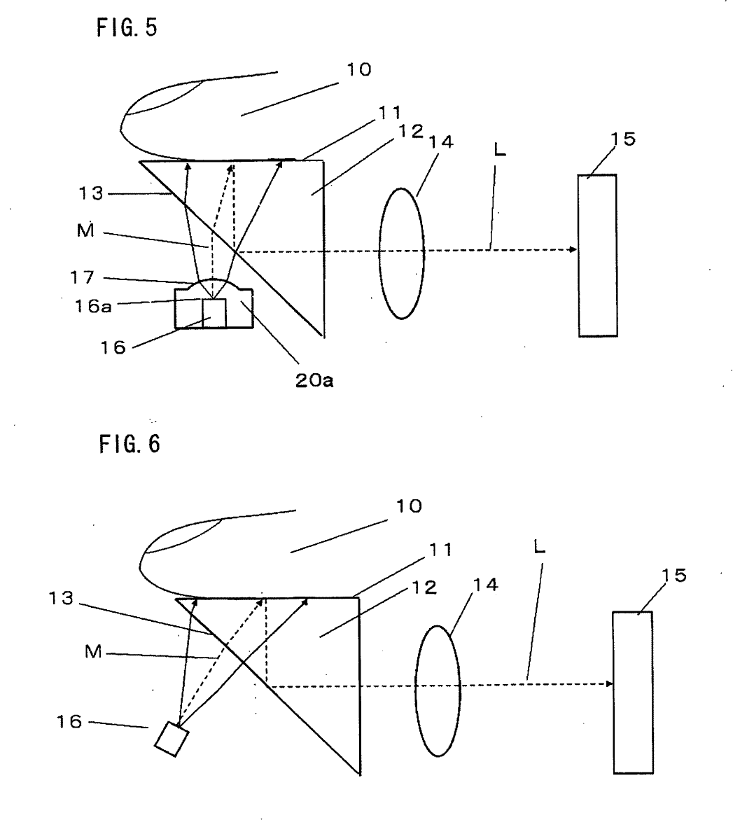

FIG. 5 is a view illustrating how an optical system of an optical pointing device 1 of the present invention works in accordance with Embodiment 2, in a case where a fingertip 10 is used as an object.

According to the present embodiment, a light source module includes (i) an LED light source 16 and (ii) a condensing lens 17 on a light emitting surface 16a of the LED light source 16 (see FIG. 5).

Here, the condensing lens 17 is formed integral with a sealing resin 20a which is provided to prevent deterioration of the LED light source 16. This makes it possible to arrange the condensing lens 17 so that a lens surface of the condensing lens 17 and the light emitting surface 16a are positioned relatively close to each other. With the arrangement, it is possible to condense, with a lens surface having a small area, light emitted from the LED light source 16, even a light beam having high radiant emittance among the light emitted from the LED light source 16. That is, the condensing lens 17 is provided as a lens for suppressing the LED light source 16 in radiant emittance.

The light emitted from the LED light source 16 is condensed by the condensing lens 17. This makes it possible to efficiently lead, toward the fingertip 10, the light emitted from the LED light source 16, via an inclined plane 13 of a prism 12 which serves as a light-direction changing element.

It is thus possible to eliminate a waste of light. This reduces a noise component such as stray light, and therefore improves quality of a signal obtained by the image-capturing element 15. Further, it is also possible to suppress power consumption of the LED light source 16. Furthermore, by causing the condensing lens 17 to have a half hemispherical shape or a bullet shape, it becomes possible to increase the aforementioned effects.

### Embodiment 3

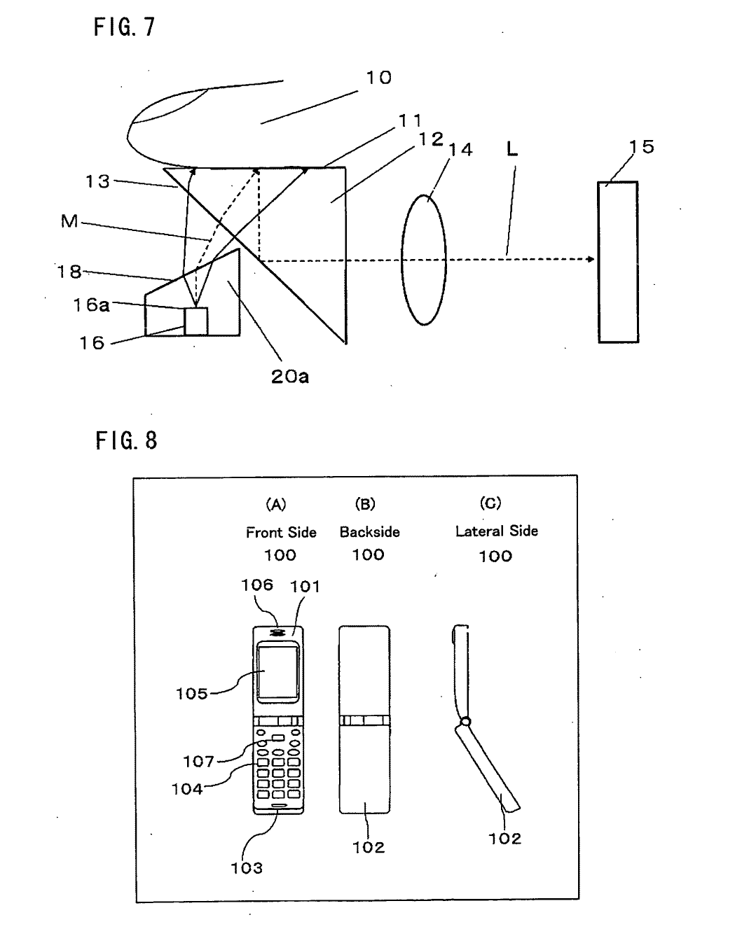

Each of FIGS. 6 and 7 is a view illustrating how an optical system of an optical pointing device 1 of the present invention works in accordance with Embodiment 3 of the present invention, in a case where a fingertip 10 is used as an object.

As described in Embodiment 1, in a case where light is obliquely incident on a contact surface, shadows of concavities and convexities of an object, such as a fingerprint, are likely to be generated. High contrast can be thus obtained in formation of an image of the object. It is thus possible to improve a recognition rate.

The present embodiment deals with a method of illuminating the contact surface 11 with light more obliquely.

In a case where an optical axis M of an illumination optical system is inclined to be close to a direction of a normal line with respect to an inclined plane 13 of a prism 12 which serves as a light-direction changing element, it becomes possible to illuminate the contact surface 11 with light more obliquely (see FIG. 6). However, provision of an LED light source 16 in such a position causes a problem of difficulty in assembling the device.

In order to solve the problem, the optical pointing device 1 includes such a light source module that a tapered surface 18 is provided above a light emitting surface 16a of an LED light source 16 (see FIG. 7). With the arrangement, the light emitted from the LED light source 16 is refracted by the tapered surface 18 so that the optical axis M of the illumination optical system is inclined toward the direction of the normal line with respect to the inclined plane 13 of the prism 12 which serves as the light-direction changing element. That is, with the arrangement, it becomes possible to cause the light indicated by the optical axis M of the illumination optical system to be incident on the contact surface 11 more obliquely.

According to the arrangement illustrated in FIG. 7, it is unnecessary to provide the LED light source 16 itself obliquely. Further, the arrangement can be obtained only by obliquely providing a light exit plane of a resin mold 20 sealing the LED light source 16, as the tapered surface 18. This arrangement has advantages of a low production cost and high alignment accuracy.

Alternatively, it is possible to provide such a light module (not illustrated) that a diffraction element is provided on the light emitting surface 16a of the LED light source 16. With the arrangement, the light emitted from the LED light source 16 is diffracted by the diffraction element so that the optical axis M of the light is inclined toward the direction of the normal line with respect to the inclined plane 13 of the prism 12 which serves as the light-direction changing element. That is, with the arrangement, it also becomes possible to cause the light indicated by the light axis M of the illumination optical system to be incident on the contact surface 11 more obliquely. In this case, it is also unnecessary to provide the LED light source 16 itself obliquely. Further, the arrangement can be obtained only by providing a diffraction grating on the surface of the resin mold 20 sealing the LED light source 16. By employing a diffraction grating having a relief shape, it becomes possible to simultaneously form the diffraction grating and the resin mold 20 sealing the LED light source 16.

### Embodiment 4

Embodiment 4 of the present invention deals with a mobile phone, which is an electronic device, including an optical pointing device of the present invention.

(A) through (C) of FIG. 8 illustrate an arrangement of the mobile phone. (A) of FIG. 8 is a view illustrating a front side of a mobile phone 100. (B) of FIG. 8 is a view illustrating a backside of the mobile phone 100. (C) of FIG. 8 is a view illustrating a lateral side of the mobile phone 100.

The mobile phone 100 of the present embodiment includes a monitor-side housing 101, an operator-side housing 102, a microphone section 103, a numeric keypad 104, a monitor section 105, a speaker section 106, and an optical pointing device 107 of the present invention.

The speaker section 106 and the microphone section 103 are used to input/output sound information. The monitor section 105 is used to output image information. According to Embodiment 4 of the present invention, the monitor section 105 is also used to display input information entered via the optical pointing device 107.

According to Embodiment 4, the optical pointing device 107 is arranged in an upper part (viewed from a viewer's side) of the keypad 104 illustrated in (A) of FIG. 8. Note, however, that a position of the optical pointing device 107 and a direction in which the optical pointing device 107 faces in are not limited to those illustrated in (A) of FIG. 2.

According to Embodiment 4, the mobile phone 100 is a foldable-type mobile phone in which an upper housing and a lower housing are connected to each other via a hinge (see (A) through (C) of FIG. 8). The foldable-type mobile phone has been dominant in a mobile phone field. A foldable-type mobile phone having a thin body, even a mobile phone having a thickness of 10 mm or less (in a folded state), is now on the market. The thickness of the foldable-type mobile phone is becoming a significantly-important factor in terms of portability. Note, however, that, as a matter of course, the mobile phone 100 which can employ the optical pointing device 107 is not limited to this, and may be a mobile phone of another type.

A thickness of the operator-side housing 102, illustrated in a back view of (B) of FIG. 8 and a side view of (C) of FIG. 8, is determined by a total thickness of the microphone section 103, the numeric keypad 104, and the optical pointing device 107, in addition to a total thickness of internal components (not illustrated) such as a circuit substrate. Among these, the optical pointing device 107 has the greatest thickness. For this reason, causing the optical pointing device 107 to be thinner can directly lead to a thinner body of the mobile phone 100. The optical pointing device of the present invention is therefore an invention that is suitably used to produce an electronic device (such as a mobile phone) having a thinner body.

### REFERENCE SIGNS LIST

1: Optical pointing device
10: Object (fingertip)
11: Contact surface
12: Light-direction changing element (prism)
13: Inclined plane
14: Image-forming element (lens)
15: Image-capturing element
16: LED light source
17: Condensing lens
18: Tapered surface
20: Resin mold
21: Circuit substrate
22: Aperture stop
23: Prism for leading light downwardly
24: Cover
100: Mobile phone
101: Monitor-side housing
102: Operator-side housing
103: Microphone section
104: Numeric keypad
105: Monitor section
106: Speaker section
107: Optical pointing device
L: Optical axis of image-forming optical system
M: Optical axis of illumination optical system

1. An optical pointing device comprising:
a contact surface which is touched with an object;
a light source module for illuminating the contact surface with light;
a light-direction changing element having an inclined plane for changing a direction of light diffusely-reflected from the contact surface;
an image-forming element for forming an image on the basis of the light diffusely-reflected from the contact surface; and
an image-capturing element for capturing the image thus formed, the inclined plane of the light-direction changing element (i) changing a light path of the light diffusely-reflected from the contact surface and (ii) leading the light emitted from the light source module toward the contact surface by transmitting and refracting the light emitted from the light source module.

2. The optical pointing device as set forth in claim 1, wherein:
an optical axis of an image-forming optical system for forming the image on the image-capturing element and an optical axis of an illumination optical system for illuminating the contact surface with the light emitted from the light source module are different from each other.

3. The optical pointing device as set forth in claim 1, wherein:
the light source module includes (i) a light source 10 and (ii) a lens for suppressing radiant emittance of light emitted from the light source.

4. The optical pointing device as set forth in claim 1, 15 wherein:
the light source module includes (i) a light source and (ii) an element for leading, into a direction of a normal line with respect to the inclined plane of the light-direction changing element, light emitted from the light source.

5. The optical pointing device as set forth in claim 4, wherein:
the element for leading, into the direction of the normal line with respect to the inclined plane of the light-direction changing element, the light emitted from the light source, is a prism having an inclined light exit plane or a diffraction element.

6. An electronic device comprising:
an optical pointing device recited in claim 1.
